(19) United States
(12) Patent Application Publication
(10) Pub. No.: US 2008/0267499 A1
(43) Pub. Date: Oct. 30, 2008

(54) METHOD AND SYSTEM FOR AUTOMATIC DETECTION OF OBJECTS IN AN IMAGE

(75) Inventors: Harald Deischinger, Frankenmarkt (AT); Seyed Ebrahim Dehghani Bonaki, Salzburg (AT); Iris Jorgner, Mondsee (AT); Dieter Hoenigmann, Vienna (AT)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 11/742,327

(22) Filed: Apr. 30, 2007

(51) Int. Cl. G06K 9/34

(52) U.S. Cl. 382/173

(57) ABSTRACT

A method and system for automatic detection of objects in an image are provided. The method includes segmenting image data defining the image using an initial threshold to identify a plurality of objects, separating the plurality of objects into discrete structures and fitting to a predetermined shape the discrete structures. The method further includes displaying with the image an identifier for the plurality of objects defined by the discrete structures.

### BACKGROUND OF THE INVENTION

This invention relates generally to medical imaging systems, and more particularly, to automatically detecting objects using the medical imaging systems, especially objects having distinct echogenicity.

Medical imaging systems are used to image patients to obtain image data to be reviewed and analyzed both quantitatively and qualitatively. The images will often include objects or regions of interest. However, sometimes because of the small size of the object, the shape of the object or other structures adjacent or in proximity to the object, it may be difficult to detect or distinguish the object. For example, it may be difficult to detect a small lesion or tumor. Additionally, and as another example, in an in vitro fertilization (IVF) application, it may be difficult to detect and classify different ovarian follicles.

Further, it may be difficult to determine specific characteristics of the object or region of interest. For example, using some imaging modalities, such as ultrasound imaging, it may be difficult to determine the size or dimensions of a particular object. In many cases such an evaluation must be performed using a manual process, for example, where a user selects various points along an image of an object that are then used to measure the length and/or dimensions of the object. For example, in order to determine ovarian follicular maturity, which is an important step in IVF, a user manually classifies each of a number of follicles by measuring the length of each one. This manual process, including the volume scanning, which can take several scans to distinguish between multiple follicles, and thereafter measuring the length of each follicle (e.g., using a software measurement tool), is a time consuming and tedious process. Also, sometimes not all follicles are identified because of the closeness of the follicles and the deformation of the follicles.

Thus, known systems and methods for generating and displaying images of objects or regions of interest may take a significant amount of time to perform. Analyzing the images is also particularly time consuming and often tedious. Further, objects of interest may be missed when manually reviewing or analyzing the images.

### BRIEF DESCRIPTION OF THE INVENTION

In accordance with an embodiment of the invention, a method for automatically identifying objects in an image is provided. The method includes segmenting image data defining the image using an initial threshold to identify a plurality of objects, separating the plurality of objects into discrete structures and fitting to a predetermined shape the discrete structures. The method further includes displaying with the image an identifier for the plurality of objects defined by the discrete structures.

In accordance with another embodiment of the invention, a medical image displaying device is provided that includes a display portion having at least one image including indicators of identified objects. The medical image displaying device further includes a list of the identified objects that automatically classifies the objects based on the indicators.

In accordance with yet another embodiment of the invention, an ultrasound imaging system is provided that includes a processor configured to process acquired ultrasound image data and an object detection module configured to automatically detect objects of distinct echogenicity. The ultrasound imaging system further includes a display configured to display the detected objects with an associated indicator.

### BRIEF DESCRIPTION OF THE DRAWINGS

FIG. 1 is a block diagram of a medical imaging system formed in accordance with an embodiment of the invention.

FIG. 2 is a pictorial view of a handheld medical imaging system formed in accordance with an embodiment of the invention.

FIG. 3 is a pictorial view of a hand carried medical imaging system formed in accordance with an embodiment of the invention.

FIG. 4 is a pictorial view of a portable medical imaging system formed in accordance with an embodiment of the invention.

FIG. 5 is a flowchart illustrating a method for performing automatic detection of objects in an image in accordance with various embodiments of the invention.

FIG. 6 is a display screen illustrating selection of a region of interest in accordance with various embodiments of the invention.

FIG. 7 is an image showing identified objects after an initial segmentation in accordance with various embodiments of the invention.

FIG. 8 is a display screen illustrating outlined objects identified in accordance with various embodiments of the invention.

FIG. 9 is a display screen illustrating color filled objects identified in accordance with various embodiments of the invention.

FIG. 10 is a display screen illustrating an overview panel providing information relating to identified objects in accordance with various embodiments of the invention.

### DETAILED DESCRIPTION OF THE INVENTION

The foregoing summary, as well as the following detailed description of certain embodiments of the present invention, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or a block of random access memory, hard disk, or the like). Similarly, the programs may be stand alone programs, may be incorporated as subroutines in an operating system, may be functions in an installed software package, and the like. It should be understood that the various embodiments are not limited to the arrangements and instrumentality shown in the drawings. Moreover, the various steps described herein are not limited to a particular order, but may be implemented or performed in a different order than those described.

As used herein, an element or step recited in the singular and proceeded with the word “a” or “an” should be understood as not excluding plural said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Various embodiments of the invention provide a method and diagnostic imaging system that automatically detects objects in an image. For example, in ultrasound imaging, the various embodiments automatically detect objects having distinct echogenicity. It should be noted that when reference is made herein to an image or image data, this may refer to any type of image data. For example, the various embodiments may be implemented in connection with three-dimensional (3D) volume data or two-dimensional (2D) image data. Accordingly, the various embodiments are not limited to detecting object in a particular type of image or type of image data. The diagnostic imaging system may be any type of system, for example, different types of medical imaging systems, such as an ultrasound imaging system, an x-ray imaging system, a computed-tomography (CT) imaging system, a single photon emission computed tomography (SPECT) system, a positron emission tomography (PET) imaging system, a nuclear medicine imaging system, a magnetic resonance imaging (MRI) system, and combinations thereof (e.g., a multi-modality imaging system), among others. However, the various embodiment are not limited to medical imaging systems or imaging systems for imaging human subjects, but may include non-medical systems for imaging non-human objects and for performing non-destructive imaging or testing, security imaging (e.g., airport security screening), etc.

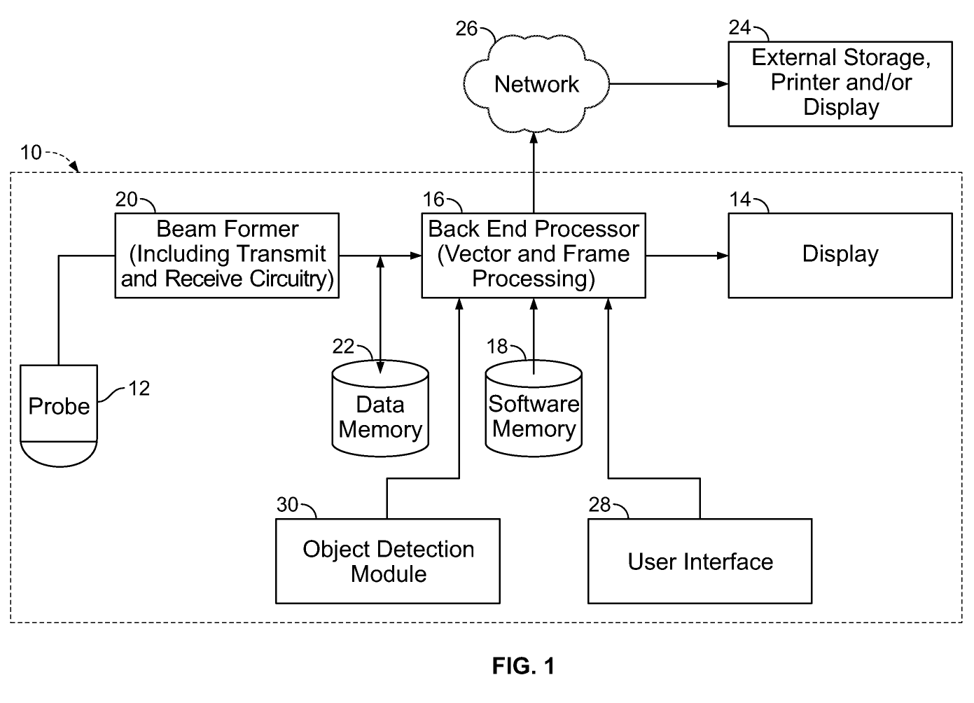

FIG. 1 is a block diagram of a medical imaging system 10 having a probe or transducer 12 configured to acquire raw medical image data. In some embodiments, the probe 12 is an ultrasound transducer and the medical imaging system 10 is an ultrasound imaging apparatus. A display 14 (e.g., an internal and/or integrated display) is also provided and is configured to display one or more medical images. A data memory 22 stores acquired raw image data, which may be processed by a beam former 20 in some embodiments of the invention.

To display a medical image using the probe 12, a back end processor 16 is provided with a memory, for example, a software or firmware memory 18 containing instructions to perform frame processing and scan conversion using acquired raw medical image data from the probe 12, possibly further processed by the beam former 20. Dedicated hardware may be used instead of software and/or firmware for performing scan conversion, or a combination of dedicated hardware and software, or software in combination with a general purpose processor or a digital signal processor. Once the requirements for such software and/or hardware and/or dedicated hardware are gained from an understanding of the descriptions of embodiments of the invention contained herein, the choice of any particular implementation may be left to a hardware engineer and/or software engineer. However, for purposes of the present disclosure, any dedicated and/or special purpose hardware or special purpose processor is considered subsumed in the block labeled “back end processor 16.”

The software or firmware memory 18 can comprise a read only memory (ROM), random access memory (RAM), a miniature hard drive, a flash memory card, or any kind of device (or devices) configured to read instructions from a machine-readable medium or media. The instructions contained in the software or firmware memory 18 further include instructions to produce a medical image of suitable resolution for display on the display 14, to send acquired raw image data stored in a data memory 22 to an external device 24, such as a computer, and other instructions to be described below. The image data may be sent from the back end processor 16 to the external device 24 via a wired or wireless network 26 (or direct connection, for example, via a serial or parallel cable or USB port) under control of the back end processor 16 and a user interface 28. In some embodiments, the external device 24 may be a computer or a workstation having a display and memory. The user interface 28 (which may also include the display 14) also receives data from a user and supplies the data to the back end processor 16. In some embodiments, the display 14 may include an x-y input, such as a touch-sensitive surface and a stylus (not shown), to facilitate user input of data points and locations.

The medical imaging system 10 also includes an object detection module 30. The object detection module 30 is configured to provide segmentation of image data to automatically detect objects. For example, in an ultrasound application, a topological segmentation may be performed with objects having distinct echogenicity automatically detected using various embodiments of the invention as described in more detail herein. The detected objects may be identified on the display 14 graphically (e.g., color overlay), textually (e.g., a list of detected objects) or a combination thereof.

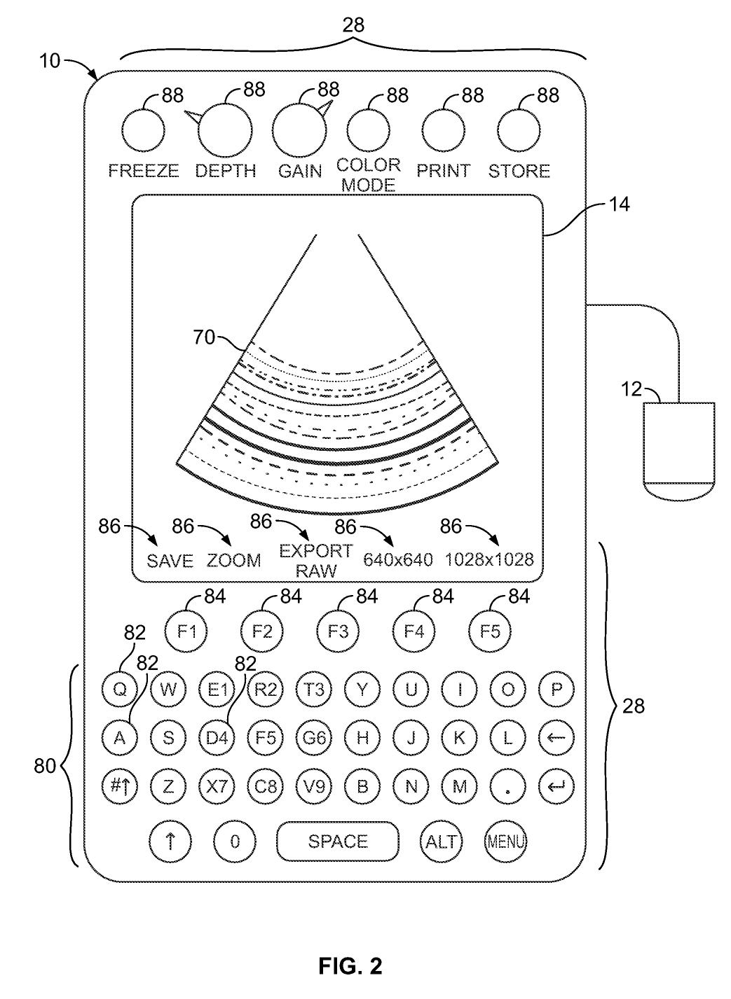

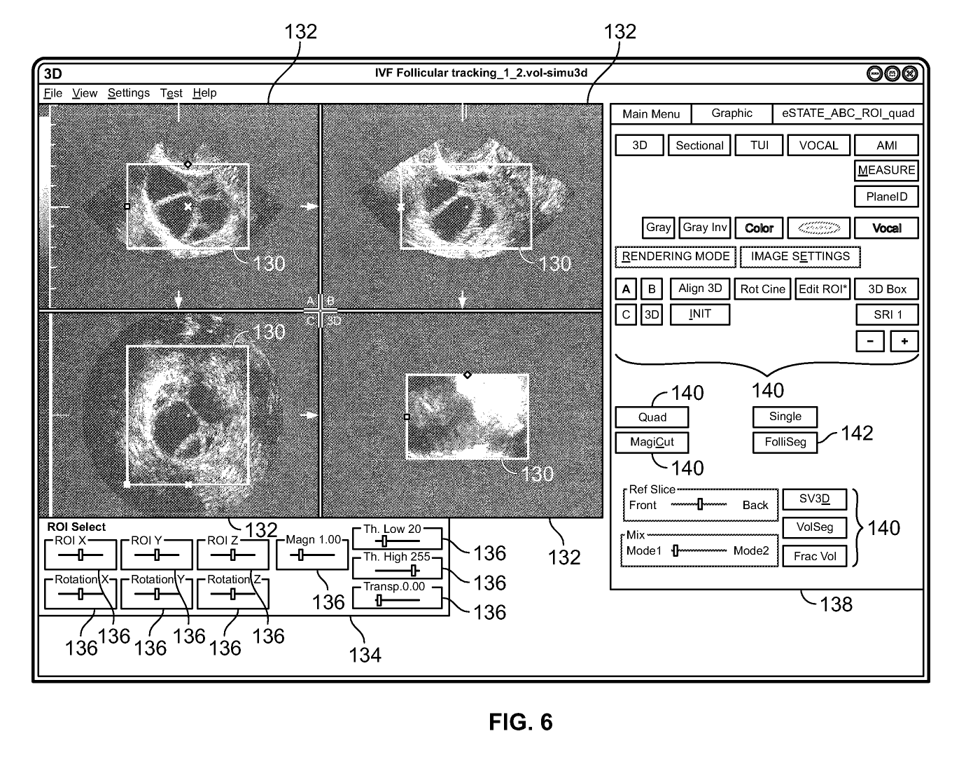

The various embodiments may be implemented in connection with medical imaging systems that are stationary, mobile or portable. For example, FIG. 2 is a pictorial drawing of an embodiment of the medical imaging system 10 configured as a miniaturized device. As used herein, “miniaturized” means that the imaging system is a handheld or hand-carried device or is configured to be carried in a person's hand, pocket, briefcase-sized case, or backpack. The medical imaging system 10 shown in FIG. 2 is a handheld device that is generally pocket-sized. By way of example, the device may be approximately 2 inches wide, approximately 4 inches in length, and approximately 0.5 inches in depth and weigh less than 3 ounces. The medical imaging system 10 includes the display 14, for example, a 320×320 pixel color LCD touch-sensitive display (on which a medical image 70 may be displayed) and the user interface 28. In some embodiments of the present invention, a typewriter-like keyboard 80 of buttons 82 is included in the user interface 28, as well as one or more soft keys 84 that may be assigned functions in accordance with the mode of operation of the medical imaging system 10. A portion of the display 14 may be devoted to labels 86 for soft keys 84. For example, the labels shown in FIG. 2 allow a user to save the current raw medical image data, to zoom in on a section of image 70 on the display 14, to export raw medical image data to the external device 24 (shown in FIG. 1), or to display (or export) an image having a resolution of either 640×640 pixels or 1028×1028 pixels. The device may also have additional keys and/or controls 88 for special purpose functions, which may include, but are not limited to “freeze,” “depth control,” “gain control,” “color-mode,” “print,” “store” and “automatic segmentation” (e.g., shown as a FolliSeg virtual button in FIG. 6), among others.

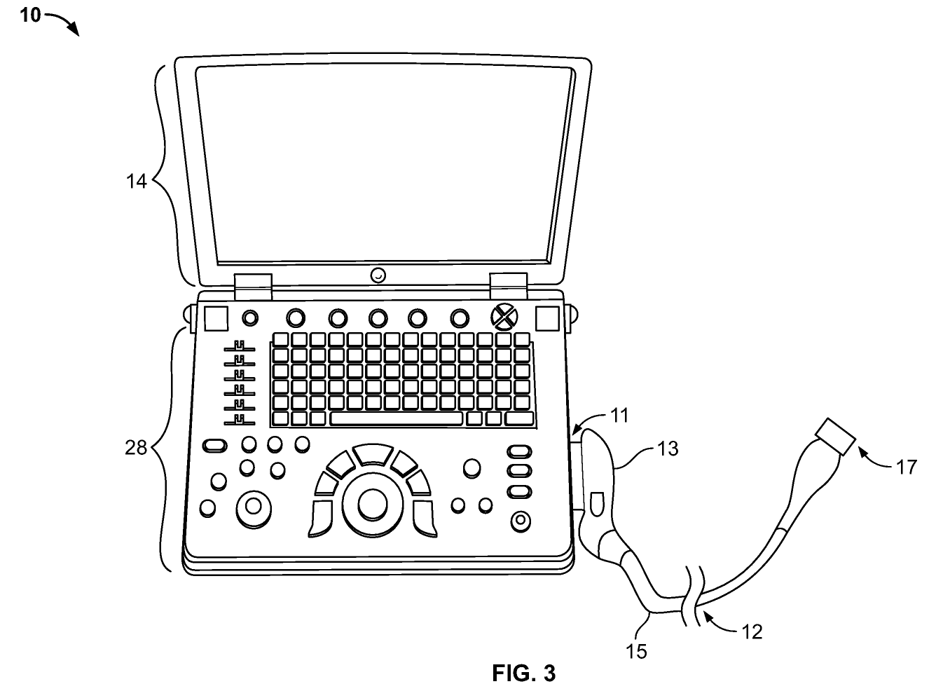

FIG. 3 illustrates the medical imaging system 10 configured as a portable or hand carried device. For example, medical imaging system 10 may be a hand-carried device having a size of a typical laptop computer, for instance, having dimensions of approximately 2.5 inches in depth, approximately 14 inches in width, and approximately 12 inches in height. The medical imaging system 10 may weigh about ten pounds. The ultrasound probe 12 has a connector end 13 that interfaces with the medical imaging system 10 through an I/O port 11 on the medical imaging system 10. The probe 12 includes a cable 15 that connects the connector end 13 and a scanning end 17 that is used to scan a patient. The medical imaging system 10 also includes the display 14 and the user interface 28.

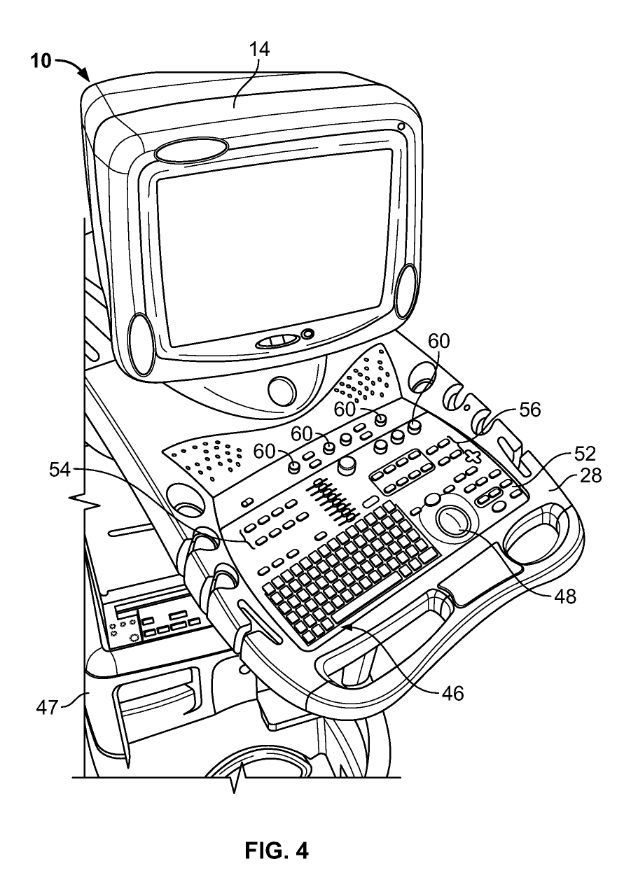

The medical imaging system 10 also may be a portable device as shown in FIG. 4. The portable medical imaging system 10 (e.g., portable ultrasound system) is provided on a movable base 47. The portable medical imaging system 10 includes the display 14 and the user interface 28. It should be understood that the display 14 may be separate or separable from the user interface 28. The display 14 optionally may be a touchscreen, allowing the user to select options by touching displayed graphics, icons, and the like.

The user interface 28 may include a keyboard 46 and a trackball 48. The user interface also may include sets of control buttons 52, 54, 56 and 60 that may be used to control the operation of the portable imaging system 10 as desired or needed, and/or as described herein. The user interface 28 provides multiple interface options that the user may physically manipulate to interact with ultrasound data and other data that may be displayed, as well as to input information and set and change scanning parameters. The interface options may be used for specific inputs, programmable inputs, contextual inputs, and the like. Different types of physical controls are provided as different physical actions are more intuitive to the user for accomplishing specific system actions and thus achieving specific system responses.

For example, the control buttons 60 may be multi-function controls that are positioned proximate to the display 14 and provide a plurality of different physical states. For example, a single multi-function control may provide movement functionality of a clockwise/counterclockwise (CW/CCW) rotary, up/down toggle, left/right toggle, other positional toggle, and on/off or pushbutton, thus allowing a plurality of different states, such as eight or twelve different states. Different combinations are possible and are not limited to those discussed herein. Optionally, less than eight states may be provided, such as CW/CCW rotary functionality with at least two toggle positions, such as up/down toggle and/or left/right toggle. Optionally, at least two toggle positions may be provided with pushbutton functionality. The multi-function controls may be configured, for example, as joystick rotary controls.

The multi-function controls also may be associated with labels (not shown) displayed on the display 14. Alternatively, a label may be displayed on a different display area such as an LED or other small display located proximate to an associated multi-function control. The multi-function controls (and other programmable controls) may be context sensitive and thus context sensitive information may be displayed on the associated label. The label indicates a system parameter that is associated with and changed by a physical action of the multi-function control within the current context or system state. The system parameter is linked to a system action or response. The physical action may be predetermined, for example, based on one that is most logical to the user to accomplish the associated system action. If the multi-function control is context sensitive, the system parameters associated with the physical actions may change based on the ultrasound application and/or context or state of the ultrasound machine. For example, the associations may be different when acquiring a cardiac scan compared to a liver scan compared to an ovarian scan. Depending upon what machine state the portable medical imaging system 10 is in, one or more of the physical actions of the multi-function controls may be mapped to a different system parameter and/or may not be assigned or mapped to any system parameter.

Embodiments of the invention can comprise software or firmware instructing a computer to perform certain actions. Some embodiments of the invention comprise stand-alone workstation computers that include memory, a display, and a user input interface (which may include, for example, a mouse, a touch screen and stylus, a keyboard with cursor keys, or combinations thereof). The memory may include, for example, random access memory (RAM), flash memory, read-only memory. For purposes of simplicity, devices that can read and/or write media on which computer programs are recorded are also included within the scope of the term “memory.” A non-exhaustive list of media that can be read with a suitable such device includes CDs, CD-RWs, DVDs of all types, magnetic media (including floppy disks, tape, and hard drives), flash memory in the form of sticks, cards, and other forms, ROMs, etc., and combinations thereof.

Some embodiments of the invention may be incorporated into a medical imaging apparatus, such as shown in FIGS. 2 through 4. In correspondence with a stand-alone workstation, the “computer” is the medical imaging system 10. For example, the back end processor 16 may comprise a general purpose processor with memory, or a separate processor and/or memory may be provided. The display 14 corresponds to the display of the workstation, while the user interface 28 corresponds to the user interface of the workstation. Whether a stand-alone workstation or an imaging apparatus is used, software and/or firmware (hereinafter referred to generically as “software”) is used to instruct the computer to perform the methods described herein. Portions of the software may have specific functions and these portions are herein referred to herein as “modules” or “software modules.” However, embodiments of the present invention are not limited to being implemented in software modules. Thus, the term “module” is also intended to encompass functions that are partly or completely implemented in hardware, with or without the use of software or firmware.

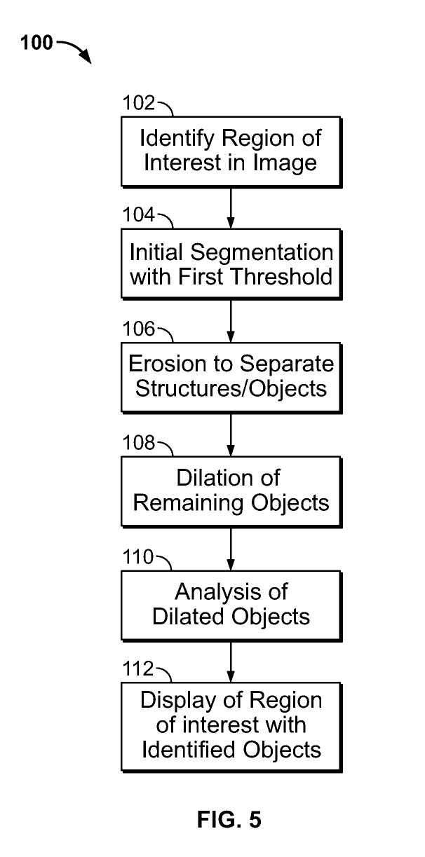

Various embodiments of the invention provide automatic detection of objects using a topological segmentation. In some embodiments, automatic detection of objects having distinct echogenicity is provided. A method 100 for performing automatic detection of objects is shown in FIG. 5. Specifically, at 102 a region of interest in an image is identified. This identification may be manual, for example, a user may select an area within a displayed image using the user interface 28 and as shown in FIG. 6. For example, a region of interest box 130 may be placed over an area of interest in a plurality of different views 132 of sectional planes of the volume of interest that define a display portion. For example, the different views 132 may correspond to three orthogonal slices through a volume. Thus, by defining a two-dimensional area in each of the different views, the region of interest box 130 defines a three-dimensional volume of interest. It should be noted that the position of the slices may be changed by user, for example, with a mouse (not shown), the trackball 48 (shown in FIG. 4), or any other type of user input (e.g., rotary encoders) that may be provided as part of the user interface 28 (shown in FIG. 4).

A region of interest control panel 134 allows rotation of the different view planes using selectable members 136 (e.g., virtual slide bars) and allows defining threshold values as described in more detail below. Additionally, an image control portion 138 allows a user to select different image settings, etc, as is known using selectable members 140 (e.g., virtual buttons). It should be noted that an automatic segmentation button 142 may be provided, which when selected, performs automatic segmentation and identification of objects as described below. For example, the automatic segmentation button 142 may be specific to the application or image volume (e.g., a follicle segmentation (FolliSeg) button).

The region of interest also may be automatically selected, for example, based on the type of image displayed and particular information of interest. For example, if particular structures in an image are to be measured, then based on a predefined typical image scan, the region(s) where the structures (e.g., follicles) typically or most often appear are selected. The user may modify the selected regions, for example, to increase or decrease the region of interest to encompass more or less of the total displayed image volume. It should be noted that the data used to generate the displayed image may be any type of data, for example, a Cartesian three-dimensional (3D) ultrasound B-mode data set. However, the data set is not limited to ultrasound data or to diagnostic medical image data.

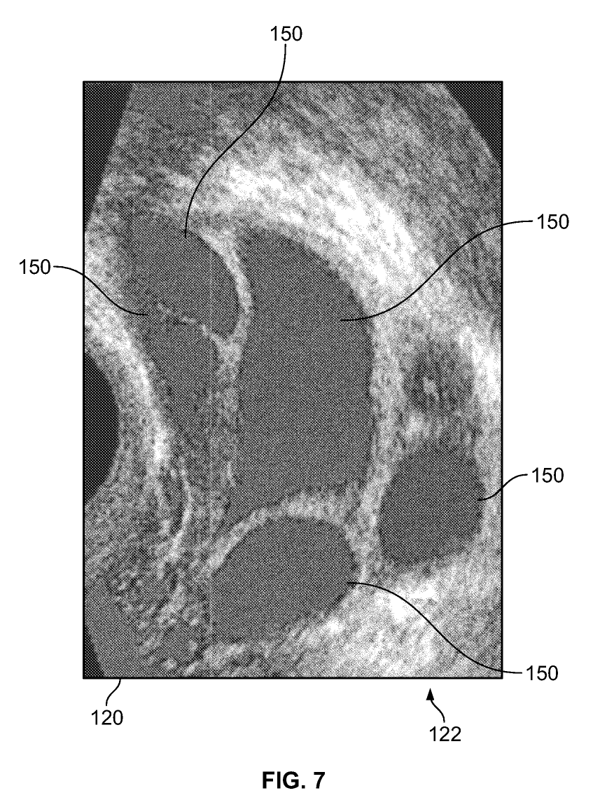

Once a region of interest has been identified, an initial segmentation is performed at 104 using an initial threshold, also referred to as a first threshold (that may be selected using the Th. Low selectable member 136 shown in FIG. 6). For example, a predetermined voxel intensity threshold is used to identify objects in the region of interest. For example, the first threshold may be a low intensity threshold to include any voxels that may be considered an object (e.g., organ filled with a liquid, etc.), which are voxels that are below the first threshold. The initial segmentation can include all physical objects within the region of interest, which may include objects of interest as well as objects and other image characteristics that are not of interest (e.g., noise). The first threshold may be derived from an intensity distribution of the entire volume displayed and the value selected based on known values for different objects. Thus, the first threshold may be set at a percentile of the overall distribution, for example, at a ten percent percentile of the volume data. This initial segmentation may result in a plurality of connected structures or objects and may be displayed on a display. Thus, physically distinct objects may still be connected in the initial segmentation. All identified objects having voxel intensities satisfying the first threshold may be colored on the display, for example, using a color overlay. However, other indications (e.g., outline of the objects) may be provided or no indication may be provided. Thus, for example, as shown in FIG. 7, several objects 150 may be identified in a displayed image 122. It should be noted that a smoothing process may be performed on the initial image data to, for example, remove noise. In one embodiment, this smoothing process is performed before the initial segmentation. The noise can limit the efficiency of various steps of the method 100 described below.

After performing the initial segmentation, an erosion process is performed at 106 to separate objects into discrete structures. This process includes separating the objects in the initial segmentation into discrete structures, for example, distinct spherical structures by removing connecting elements between the objects. It should be noted that for each distinct object in the initial segmentation an erosion radius can be determined independently as described below. For example, the radius of objects may be, for example, proportional to the compactness of the object, namely the ratio of the surface to the volume. Accordingly, more compact objects (e.g., more sphere-like objects) are eroded less than less-compact objects, which typically include, for example, ultrasound shadows or noisy structures. Thus, connecting “bridges” between objects (e.g., generally spherical objects) may be removed leaving only the spherical objects, which in this example, are the follicles. These objects each may be identified on the display using a different color, for example, a different color overlay filling the object or outlining the object.

In another embodiment, a shape based identification (e.g., geometric shape matching) may be performed on the objects identified in the initially segmented image. This can include using predefined or predetermined shapes based on the type of image displayed, the region of interest, etc. For example, to identify ovarian follicles, a determination may be made based on identifying spherical objects that are connected by “bridges” or rod-like structures.

It should be noted that after the erosion process, the objects are segmented into distinct structures. The erosion step identifies the discrete structures defining the objects, but may not result in structures having the actual or correct size. For example, the size of the structures may be underestimated. Accordingly, thereafter a dilation process is performed.

The dilation process is performed at 108 on the remaining objects defined by the discrete structures. Continuing with the ovarian follicle example, an assumption may be made that a single small object or “seed” is present in each hypoechoic structure, namely each separately identified object. The number of voxels that define that structure are then increased (without merging) until an edge in the original data set is reached. This dilation (or inflation) process is essentially the reverse of the erosion process (e.g., a fitting process), except that it is applied only to the discrete structures identified. The dilation may be performed such that a dilation radius, for example, for spherical objects, is based on the underlying volume data. Each discrete structure that defines an object is dilated individually. Thus, each object has a distinct dilation radius. The discrete structures are dilated, for example, in a stepwise process or manner until the structure encounters or touches as many edges as possible (e.g., a maximum number of edges without overlapping) in the underlying volume data set, thereby providing an active contour. To determine when edges are encountered or touched, a gradient of the volume data may be computed followed by searching the dilation radius for the sum of the magnitudes of the gradients at the border of the structures that are maximal. It should again be noted that the structures are prevented from overlapping such that no two objects combine. This process also may be performed or displayed, for example, using an edge image having outlines of different structures with the objects allowed to expand in size until the contour of that object touches a maximum number of edge positions.

It should be noted that the volume data may be preprocessed for determining the edges based on a second threshold, namely a second voxel intensity threshold (that may be selected using the Th. High selectable member 136 shown in FIG. 6). The second voxel intensity threshold in one embodiment is greater than the first voxel intensity threshold used during the initial segmentation. For example, the second voxel intensity threshold may be based on the typical, maximum or minimum voxel intensity value for a voxel of an imaged follicle. All voxels above the second threshold may be removed such that no edges are detected in hyperechoic regions of the data set. The second threshold value may be, for example, at a fifty percent percentile of the volume data, for example, based on the intensity distribution.

Also, in another embodiment, the dilation of each object may continue until a significant change in adjacent voxel intensities is determined. For example, if the change in intensities between adjacent voxels or sets of voxels is greater than a third threshold, the dilation of that object is halted. Essentially, this dilation process grows or expands the size of the objects, however, the number of objects does not change. Moreover, any color coding or labeling provided during the erosion is maintained during the dilation.

The various embodiments may perform other types of dilation or inflation to grow or expand the areas of the objects. In particular, any process to add voxels to each of the objects that is limited by some type of edge detection may be used.

Once the identified objects are dilated, an analysis of the objects is performed at 110. Continuing with the follicle example, the follicles are measured, such as measuring the size or length of each of the follicles, using any software measurement tool known in the art. Other measurements also may be performed, for example, measurement of follicle volume, diameter, etc. In general, any parameter of the objects may be measured, for example, the size of the object, the compactness of the object, the principal axis of the object, a best fitting ellipsoid of same inertia, a maximal diameter or length of the object, among others.

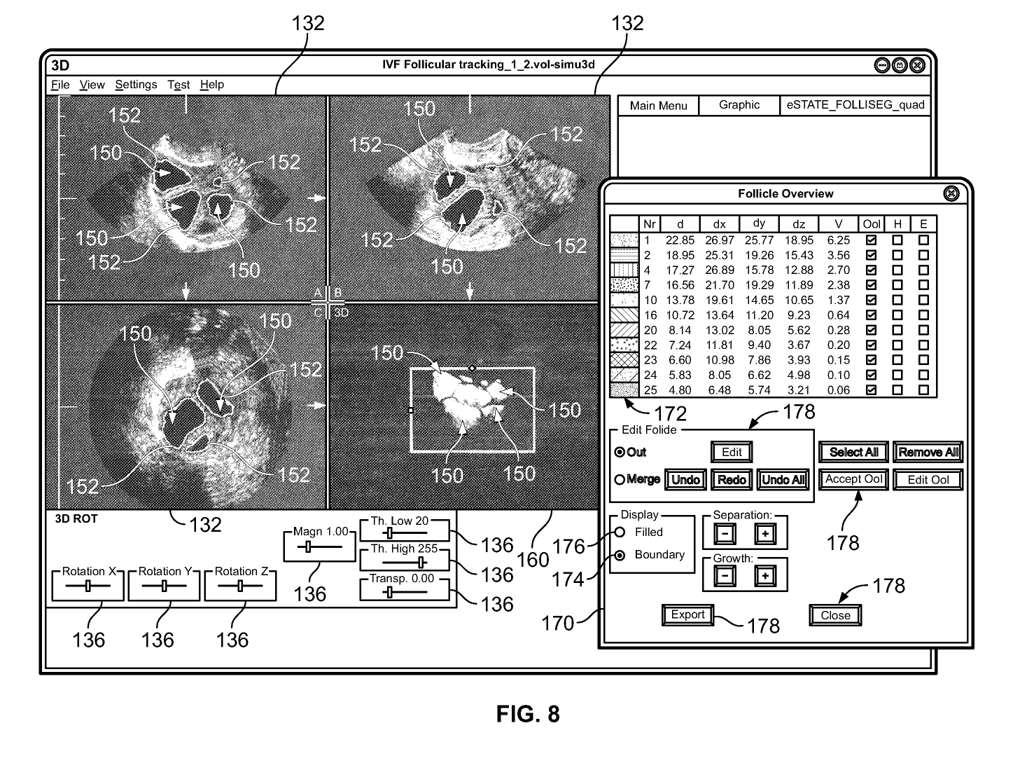

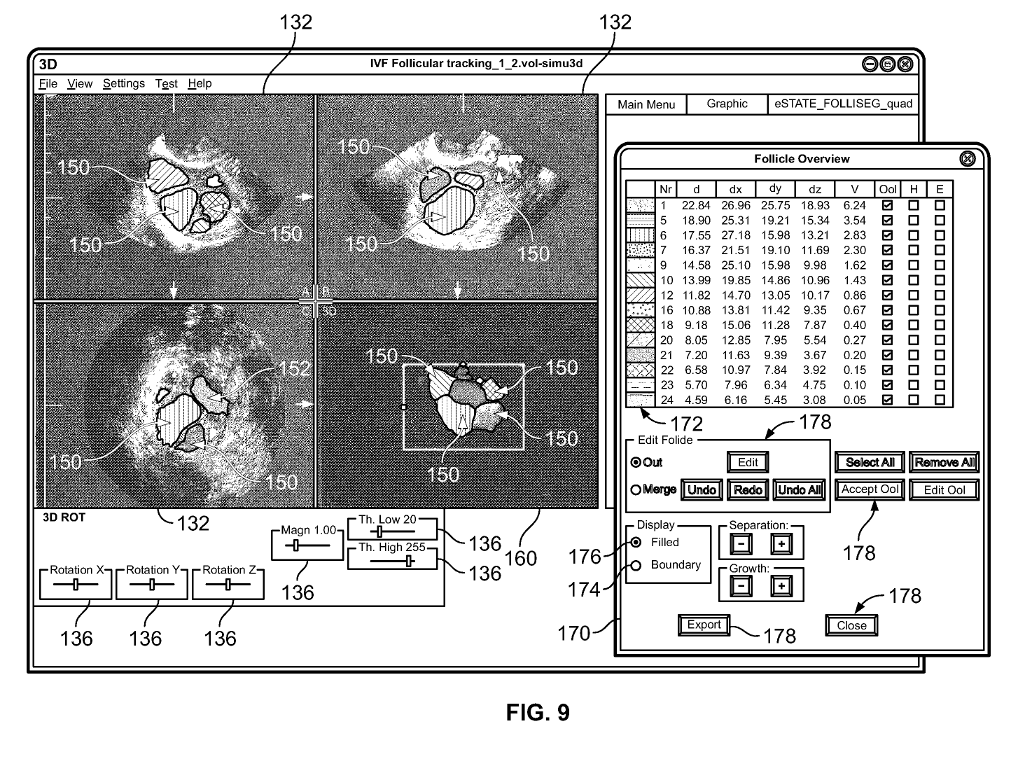

Thereafter, the region of interest with identified objects is displayed at 112. For example, as shown in FIG. 8, in the sectional plane views 132, the contours of the identified objects 150 are indicated using outlines 152, than may be color coded. For example, a different color may correspond to each displayed object 150 in the various views. Alternatively, the entire displayed object 150 may be color filled as shown in FIG. 9. A rendered image is provided in the view 160 of FIGS. 8 and 9 that shows a volume rendering of the objects 150 with the color coding maintained. Continuing with the example from above, the objects are volume rendered follicles automatically identified using the method 100. It should be noted that in the rendering view 160 the brightness for the rendered objects 150 is determined from the image data set (e.g., the ultrasound data set) and the color for the objects 150 is determined from the segmentation. It should be noted that a lookup table may be provided to store different related information, for example, a lookup table that defines the color of an object based on the object label.

An overview portion 170 is also provided that includes data relating to each of the objects 150. The data includes, for example, the length of the object 150 (e.g., follicle), a volume of the object 150, etc. Dimensions of the objects in the x, y and z direction also may be determined and displayed based on a best fitting ellipsoid. For example, an ellipsoid is determined to be best fitting when the inertia of the object and the ellipsoid are equal. The diameters of the principal axes of the ellipsoid are then displayed. The data for each object 150 is provided in a separate line with each line having a color indicator 172 corresponding to the object 150 colored the same in the views 132 and 160. It should be noted that a user can select between identifying objects 150 with an outline using a boundary selectable member 174 and identifying objects 150 with a color filled area using a filled selectable member 176. Other selectable members 178 also may be provided, for example, to edit the objects 150 (e.g., edit the follicles), export the images, etc.

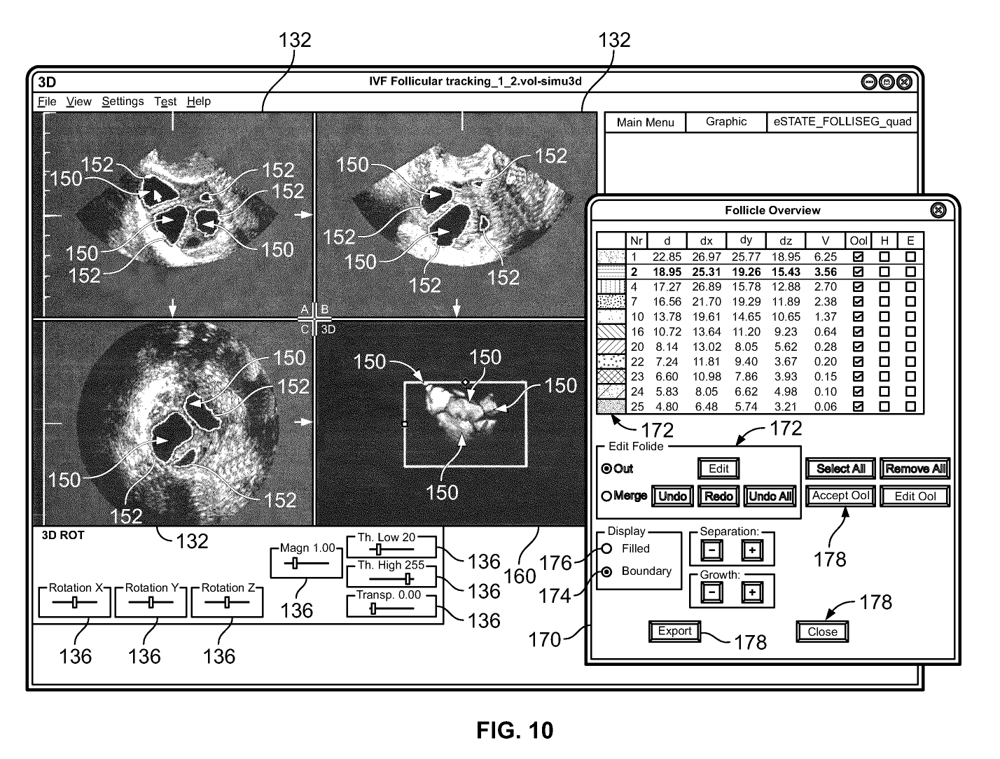

It should be noted that if a user moves a cursor or selects a particular object 150 (e.g., follicle) in one of the views 132 and 160, the corresponding line in the overview portion 170 will be identified (e.g., highlighted) as shown in FIG. 10. Also, when a user selects a line on the overview portion 170 the corresponding object 150 is identified (e.g., highlighted).

A technical effect of at least one embodiment is automatically identifying objects in a displayed image. Topological segmentation is performed that facilitates identification and analysis of objects of interest in an image.

The various embodiments and/or components, for example, the controllers and processors for generating the displayed images also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a floppy disk drive, optical disk drive, and the like. The storage device may also be other similar means for loading computer programs or other instructions into the computer or processor.

As used herein, the term “computer” may include any processor-based or microprocessor-based system including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program. The software may be in various forms such as system software or application software. Further, the software may be in the form of a collection of separate programs, a program module within a larger program or a portion of a program module. The software also may include modular programming in the form of object-oriented programming. The processing of input data by the processing machine may be in response to user commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. § 112, sixth paragraph, unless and until such claim limitations expressly use the phrase “means for” followed by a statement of function void of further structure.

What is claimed is:

1. A method for automatically identifying objects in an image, the method comprising:
segmenting image data defining the image using an initial threshold to identify a plurality of objects;
separating the plurality objects into discrete structures;
fitting to a predetermined shape the discrete structures; and
displaying with the image an identifier for the plurality of objects defined by the discrete structures.

2. A method in accordance with claim 1 wherein the initial threshold comprises a voxel intensity threshold.

3. A method in accordance with claim 1 further comprising automatically measuring a size of the identified objects.

4. A method in accordance with claim 1 wherein the separating is based on a surface to volume ratio.

5. A method in accordance with claim 1 wherein the separating comprises removing connecting elements between the discrete structures.

6. A method in accordance with claim 1 wherein the initial threshold is based on user defined settings.

7. A method in accordance with claim 1 wherein the displaying comprises graphically overlaying an indicator on each of the objects.

8. A method in accordance with claim 7 wherein the overlaid indicator is color coded and comprises one of an outline outlining the object and a fill area filling the object.

9. A method in accordance with claim 1 wherein the displaying comprises providing text indicators relating to the objects.

10. A method in accordance with claim 1 wherein the fitting comprises applying an active contour.

11. A method in accordance with claim 1 wherein the image comprises ultrasound image data and the objects are defined by a distinct echogenicity.

12. A method in accordance with claim 1 wherein the objects comprise ovarian follicles.

13. A method in accordance with claim 1 further comprising associating each of the identified objects with an indication of measured parameters for the objects in a displayed list.

14. A medical image displaying device comprising:
a display portion having at least one image including indicators of identified objects; and
a list of the identified objects that automatically classifies the objects based on the indicators.

15. A medical image displaying device in accordance with claim 14 wherein the indicators comprise one of a color coded outline and a color coded fill area.

16. A medical image displaying device in accordance with claim 14 wherein the indicators are color coded and the list includes corresponding color identifiers.

17. A medical image displaying device in accordance with claim 14 further comprising user selectable members to define parameters for automatically detecting the identified objects.

18. An ultrasound imaging system comprising:
a processor configured to process acquired ultrasound image data;
an object detection module configured to automatically detect objects of distinct echogenicity; and
a display configured to display the detected objects with an associated indicator.

19. An ultrasound imaging system in accordance with claim 18 wherein the processor is configured to perform a first segmentation of the image data using an initial threshold and an object dilation process using an active contour.

20. An ultrasound imaging system in accordance with claim 18 wherein the object detection module is configured to highlight on a list of objects on the display an object that is selected.
